(19) United States
(12) Patent Application Publication
(10) Pub. No.: US 2013/0056542 A1
(43) Pub. Date: Mar. 7, 2013

(54) METHOD AND APPARATUS FOR PRODUCING A BARCODE ON A SUBSTRATE AND DATA CARRIER

(71) Applicants: FRANK GNUTZMANN, GETTORF (DE); PETER EDUARD WEINHOLZ, BLICKSTEDT (DE)

(72) Inventors: FRANK GNUTZMANN, GETTORF (DE); PETER EDUARD WEINHOLZ, BLICKSTEDT (DE)

(73) Assignee: HEIDELBERGER DRUCKMASCHINEN AKTIENGESELLSCHAFT, HEIDELBERG (DE)

(21) Appl. No.: 13/586,043

(22) Filed: Aug. 15, 2012

(30) Foreign Application Priority Data
Sep. 1, 2011 (DE) 10 2011 112 232.3

(51) Int. Cl. G06K 19/06

(52) U.S. Cl. 235/494

(57) ABSTRACT

A method and apparatus for producing a barcode on a substrate reproduce the barcode to adapt it during a workflow. All information about the barcode is procured and the page is reproduced. If not all the information about the barcode is known, problems can occur. Therefore, a first section is created within a first region in a file, describing a first barcode, the region is made unambiguously identifiable using identification elements of a PDL and, when re-opening, the file is identified using the identification elements and the first barcode is accessed. Changes can be made to individual parameters and/or contents of the first barcode and can be used to produce a changed first region. A substrate is then imaged in an imaging device producing the barcode while taking the changes in the image region into account. A data carrier stores a computer program for carrying out the method.

### CROSS-REFERENCE TO RELATED APPLICATION

This application claims the priority, under 35 U.S.C. §119, of German Patent Application DE 10 2011 112 232.3, filed Sep. 1, 2011; the prior application is herewith incorporated by reference in its entirety.

### BACKGROUND OF THE INVENTION

1. Field of the Invention

The present invention relates to a method for imaging a substrate, in which an image is produced on the surface of the substrate and the imaging produces at least one image region which contains a barcode. Furthermore, the invention relates to a data carrier for storing a computer program which is used to carry out the method. Additionally, the invention relates to an apparatus for imaging a substrate with an image, in which the image has at least one image region that contains a barcode, including an imaging device for printing plates and/or a printing press and at least one first computer for producing a barcode for carrying out the method described. The imaging device for printing plates and the printing presses are intended to be used in each case for imaging the substrate.

So-called barcodes are used today in order to identify printed products. With regard to such barcodes, it is possible to distinguish between one-dimensional, two-dimensional and three-dimensional barcodes. Four-dimensional barcodes have already also been proposed for specific applications.

In the case of one-dimensional barcodes, they are generally strip patterns which are applied to a product in one dimension, i.e. one direction, and encode specific information there.

A 2-D barcode has an extent in two dimensions and is frequently applied to a substrate in black and white in the manner of a specific pixel configuration in a specific region and encodes corresponding information there. A 2-D barcode can substantially encode a larger amount of information as a result of using the second dimension.

A 3-D barcode corresponds substantially to a 2-D barcode but, in addition to the colors black and white, even further colored elements are used in order to increase the possible information density.

In a 4-D barcode, a change in the pixel configuration in the corresponding region over time is used as an additional information carrier.

The encoded information from the respective barcode is read through the use of a scanner which, by reading a reflection pattern in accordance with an algorithm, which must be assigned to the barcode, decodes the information, so that the information can be displayed to a user of the scanner or used in another way.

In order to produce the barcode on the substrate, a barcode production program is normally used which correspondingly produces the graphical elements of the barcode in a predefined region within a printing original from information to be encoded.

The barcode produced in that way can then be applied in its graphical form directly to a printing material or to another printed product in a printing process, such as a digital printing process. That can, for example, be an EAN-8 code which is applied to packaging of a product in order to provide information about the packaged product. That EAN-8 code can then be read at a supermarket checkout, in such a way that the product which has been packaged is identified unambiguously.

A barcode can also be used within the workflow for producing a printed product or another product, in order to identify intermediate stages of the final product through the use of the barcode in such a way that the processing steps already carried out and/or the processing steps still to be carried out are stored on the partial product itself through the use of the barcode.

In the case of a printing process which, as an intermediate step, includes the imaging of printing plates as substrates, it is thus possible, for example in a region of the printing plate which is not provided for producing the printed image, to provide an image region in which a barcode which identifies the printing plate unambiguously is imaged.

That can be expedient, for example when the color separation or the print job to which the printing plate belongs cannot merely be visually identified unambiguously. That information can then be produced by the encoded text of the barcode.

It is necessary for the production of the barcode, through the use of the barcode production program, to provide the program with all of the information which is needed to produce the barcode. That includes, for example, the type of barcode and also the size of the barcode, the size of the individual modules, the line widths and further variables which influence the form of the barcode.

It is therefore necessary for the production of the barcode to enter all of that information into the program. If the barcode is changed again, all of the inputs are also needed once more. If, for example on a pizza box, there are six barcodes, then changes must in each case be implemented through the use of a six-fold re-production of the individual barcodes. That means a considerable amount of effort and a disruption to the overall production process.

U.S. Patent Application Publication No. US 2005/0012949 A1 discloses the production of a virtual font from the individual possible parameter combinations of the barcode in order to permit greater flexibility, so that the barcode itself is produced only by displaying the information to be reproduced through the use of that font.

The barcode itself is then transmitted through the use of that font to the printer, to which those virtual fonts must be known, at least through the printer driver that is provided.

Possible adaptation of the barcode or else of only individual parameters of the barcode during different processing stages of the printing original within a workflow for producing a printed image or an image on a substrate, such as a printing plate or printing material, is not simple to implement through the use of the known production method for printing materials. In that case, too, the barcode would have to be generated newly in each case with all of the parameters which define the font.

### SUMMARY OF THE INVENTION

It is accordingly an object of the invention to provide a method and an apparatus for producing a barcode on a substrate and a data carrier, which overcome the hereinafore-mentioned disadvantages or at least reduce the described problems of the heretofore-known methods, apparatuses and data carriers of this general type.

With the foregoing and other objects in view there is provided, in accordance with the invention, a method for imaging a substrate to produce an image on a surface of the substrate and to produce at least one image region containing a barcode. The method comprises producing a file on a first computer in a page description language, the file including a printing original for imaging the substrate, creating a first section, describing a first barcode, within a first region of the file and making the first region unambiguously identifiable by using identification elements of the page description language, storing the file on a storage medium or sending the file as a data stream to a second computer, following production of the file, re-opening the file with the first or second computer, identifying the first region of the file using the identification elements, accessing the first barcode and making changes to individual parameters and/or contents of the first barcode, producing a first region with changed content within the file by using the changed parameters and/or contents, and on the basis of the file, imaging the substrate in an imaging device and physically producing the barcode in the at least one image region while taking the changed parameters and/or changed content into account.

The substrate can, for example, be any desired printing material such as a reel of paper, a paper sheet, i.e. a printing sheet, also including thicker sheets, for example of paperboard or other packaging material or film printing material in this case. The substrate can also be intermediate products in a printing process, such as printing plates.

In order to carry out the imaging and to produce the image on the surface of the substrate, the invention provides for a first computer to be used to produce a file which includes an electronic original for imaging the substrate.

The electronic original can be provided in one color, so that it corresponds to the individual color separations which are provided for the finished printed product, or it can represent the superimposition of all of the color separations. In this case, the original can have regions which do not emerge on a finished printed product. These regions can be configured in the edge region of the original in such a way that they are either cut off following an imaging operation of a printing material or are provided on a printing plate in such a way that this region is not transferred to a printing material during a subsequent printing process.

Depending on the application, however, the image region in which the barcode is produced can also lie within the image which is visible on the ultimate printed product.

The file is produced in a page description language (PDL). One possible page description language which is usual today in the production of printed products is, for example, PDF. The file should preferably be produced in this format but other page description languages are also entirely possible.

Within this file, in a first region, a first section is created which contains the data that describes a first barcode. In particular, provision can be made in this case for the barcode to be stored in a graphical representation, for example in the form of a bit map or as a text in a specific font.

Furthermore, provision is made to ensure that, within the file, the whole of the first region is made unambiguously identifiable through the use of identification elements. In a development of the invention, such identification elements can be a Form XObject, for example, which includes and describes the whole of the first region.

After the file having the first region and the first section which includes the first barcode has been produced, provision is further made for this file to be stored on a storage medium. In this case this can be a hard disk, a flash memory, a CD or DVD, for example, or it may be sent to a second computer as a data stream, for example through a network or the Internet.

This stored or sent file is then opened or re-opened by the first or by the second computer.

The first region of the file is identified by using the identification elements which are provided. In particular, the first barcode is then displayed on a monitor or another display unit with the aid of these identification elements.

Access is made to this first barcode and changes are made to individual parameters and/or to the content of the first barcode. The access can be made, for example, through a choice on a monitor or another display unit. For this purpose, the barcode from the first section is decoded and displayed on the display unit. Choices in this case are possible, firstly, through touch operation of the display unit or through the use of a mouse cursor. The barcode is selected through the use of these elements. The changes can then be made on the first barcode thus selected or made available to the access. In this case, the changes can be made only on the individual parameters, which are stored in a second section separately from the barcode itself but associated with the latter.

Through the use of the parameters changed in this way and/or the content of the barcode, a first region with changed content is then produced within the file. In this case, the first region can be supplemented or changed or, in a preferred embodiment, re-produced through the use of the changed parameters and/or contents and re-stored in the file.

The substrate is then imaged on the basis of this file with the changed first region. The imaging takes place in an imaging device. The imaging device, depending on the substrate, is for example a printing plate exposer, an inkjet printer, an electrophotographic printer or another digital printing press or else an offset printing press, in which a printing material is imaged on the basis of a printing plate in such a way that the barcode is applied to a printed sheet as an image through the route of a printing plate that is produced.

According to the invention, the barcode is then produced physically on the substrate in the at least one image region, taking the changed parameters and/or the changed content into account. The barcode can then be scanned and the substrate can then be fed to further processing steps, for example, on the basis of the data being read, i.e. as a function of this data.

In an advantageous embodiment, provision is made for at least one second section to be created within the first region of the file. Meta-information for describing the barcode is then stored within this second section. This meta-information can be information which describes the barcode as such. This includes, for example, the background color, the foreground color, the character thickness, the module height, the module width, the type of barcode, the position on the printing material or within the layout, a possible color rule, the provision of a specific border or a border to be selected, a distance marker definition, i.e. which distance markers can be provided or are distance markers provided at all, which character set is involved, which character sizes are provided in individual regions of the barcode, or which text content as such is provided as a whole. As a result of providing this meta-information, all of the information within the file should then be stored in the page description language in such a way that, in further method steps, possibly in further programs or on further computers, all of the information is provided in order to open the first barcode and to adapt the latter to further requirements, if appropriate only in individual parameters or only in terms of content. In this case, provision is made for only the file itself to be stored in the page description language. The meta-information can be stored in a private region of the second section in a proprietary file format.

On the basis of these adaptations, a first region with changed content is then produced in the file and, on the basis of this file, the substrate is imaged in an imaging device, with the barcode being produced physically in the at least one imaging region while taking the changes, i.e. the parameter changes and/or the content changes, into account.

In advantageous developments of the method, provision is made for the barcode to be stored in a graphical representation within the first section and for the meta-information for describing the barcode to be stored in a second section. As described, the meta-information can be stored in proprietary file formats and PDL encoding is therefore not necessary in this case. The meta-information within the region is thus a so-called private section of the file, which does not have to correspond to the particular specifications of the PDL.

According to the invention, the method is intended to implement a barcode that can be processed as simply as possible within a workflow. This is possible as a result of the fact that, in a first step, first of all the file having a first region is produced, then, in a second step, the file that is produced is re-opened in a second computer or else in a first computer, in a third step, the meta-data and/or the graphical data from the first section is changed or replaced, by which measures in particular second meta-data and/or a second barcode are produced. Provision is, in particular, made in this case for the second meta-data to be used as a basis for the production of the second barcode and then for the first region of the file to be replaced by a second region, with the second region including the changed first section with the changed second barcode, and the second region also including the changed second section with the changed meta-data. The second section depends on inputs made by the user and/or on operations on the substrate already carried out or else to be carried out.

The changed file which is formed in this way is then used to image the second barcode on a substrate.

Advantageously, the method is intended to permit a barcode itself to be used in the manner of a dynamic marker. For this purpose, provision is made for a third section to be produced within the first region. This third section can also involve a partial aspect of the second section.

In this third section, further data which does not correspond directly to the meta-information but has an influence on the content of the second barcode is stored. This data should preferably involve data in the form of place-holders. For this purpose, it is in particular possible for a table to be stored in a storage region of a memory, the table having possible dynamic markers, i.e. possible place-holders.

In order to produce the second barcode on the substrate, in a further step, the place-holder or place-holders are then replaced by predefined values. If, for example, the place-holder is a marker $Color$, then, before the production of the second barcode, this dynamic marker can be replaced by the appropriate value of the color separation to be imaged, e.g. cyan. On the basis of the data from the second and third sections, the second barcode is then either first produced in the first section or directly on the substrate. The place-holders can, in particular, be values such as color of the color separation, ID of the print job, ID of the customer, ID of the plate, number of the plate or date or time of day.

In a preferred embodiment of the invention, provision is made for the first region to be produced in the form of a first Form XObject of a PDF file. In this way, known elements from a PDF file can be used to identify the first region.

This Form XObject firstly includes the barcode in the form of graphical elements within a first section and the meta-information in a second section. In this case, the meta-information does not have to be stored in objects which can be gathered from the programming language used for the PDF or generally from a PDL. The at least one item of meta-information that is stored should be formed of the set including type, position, layout-specific position, relative position determination, module height, module width, line reduction, background color, foreground color, color rule, border, distance marker definition, character set, character size and text content of the barcode in the second section. Provision is made to ensure that, when a plurality of items of meta-information are used, at least one of these items of meta-information is used. In this way, particular or necessary properties of the barcode within the Form XObject together with the PDF file can be transported from one storage medium to another, such as from the random access memory of the first computer to a hard disk drive of the first computer or from a first computer to a second computer. At this second point, it is then possible to make renewed access to the barcode and in this case to gain access to all specific or necessary meta-information.

In a further advantageous embodiment, provision can be made to ensure that, in the first step, no real barcode to be used is produced within the first section of the first region. Provision is made in this case, firstly for a dummy barcode without any particular content to be produced within the first region or first section. The file having the first region provided in this way, wherein it is possible for already predefined meta-information for the barcode to be produced to be stored, in particular, in the second section, can then be processed further within a workflow for the production of printed products. In this case, in particular, a Form XObject, as described above, can be used as the first region.

Before the imaging of the substrate, provision is then made for the dummy barcode to be replaced by a specific barcode, by using the meta-information from the second section and/or the data from a third section. The above-described dynamic markers can also be used for this purpose. In this case, the meta-data is adapted accordingly in relation to the text of the specific barcode.

On the basis of the specific barcode produced in this way, a second region or a second Form XObject with the second barcode is then created, with the adapted meta-information being stored in the second section and the first Form XObject within the file or the first region being replaced by the second region or the second Form XObject.

In this way, the file has been modified in such a way that the specific barcode is stored with the associated meta-information without any particular effort having been necessary for identifying and encoding and decoding the barcode itself.

If a printing company receives a corresponding printing original having a barcode from an external customer, it may be possible for the barcode initially to include no kind of further information or, due to its configuration, for it not to be produced sufficiently well in the printing process to be provided. This original file, supplied in this way, is transmitted with the original barcode to the first computer. This original barcode is then covered or deleted by suitable measures of the PDL within the original file, should this be possible. On the basis of this original file, the file with the first region is produced, which is stored in the covered region of the original file. The first region includes in a first section the first barcode which, at least in terms of content, is intended to correspond to the original barcode. The meta-information relating to further processing, making it available within the first barcode, is then stored in the second section of the first region.

With the objects of the invention in view, there is also provided a data carrier, comprising a computer program stored on the data carrier for carrying out the method according to the invention.

With the objects of the invention in view, there is concomitantly provided an apparatus for imaging a substrate with an image having at least one image region containing a barcode. The apparatus comprises a printing plate imaging device and/or a printing press, at least one first computer configured for producing a barcode to carry out the method according to the invention, the first computer having at least one input unit and a display unit, the first computer including an interpretation module for interpretation of a file in a page description language, the file having a first region with first and second sections, the interpretation module configured to interpret the file and display the file graphically on the display unit, the first computer including at least one input module, the at least one input module having input elements for inputting meta-information from the barcode, the interpretation module and the at least one input module having an information connection to each other, the interpretation module including first reading elements reading information out of the first section of the first region of the file, the interpretation module determining a representation of the barcode as displayed on the display unit on a basis of information read out of the first section and correspondingly driving the display unit, the interpretation module including second reading elements reading meta-information from the barcode out of the second section of the first region of the file, the interpretation module being connected to the at least one input module for displaying the meta-information in input elements of the at least one input module on the display unit, the first computer having an input device permitting inputs or changes of the displayed meta-information within the input elements of the at least one input module, at least one barcode producing module configured to produce a second barcode on a basis of the meta-information being changed or entered into the input elements, at least one writing module entering inputs or changes in the displayed meta-information into the second section of the first region and/or entering the second barcode into the first section of the first region, and a storage device storing a file having first and/or second correspondingly changed sections in the first region.

The first computer should have at least one input device and a display unit. Furthermore, an interpretation module for the interpretation of a file and a page description language (PDL or PDF) should be included. This interpretation module is suitable to interpret a file for use in the imaging process and to display the regions to be imaged graphically on the display unit.

Furthermore, the first computer should include at least one input module, the input module itself having input elements for the input of meta-information about the barcode. The input of meta-information is possible through the at least one input device of the first computer. This first input device can be, for example, a keyboard, a mouse, a trackball or else a region of a touch screen of the display unit.

According to the invention, the interpretation module and the input module should have an information connection to each other. The interpretation module should include first reading elements which are able to read information from a first section of a first region of the file, with it being possible for the interpretation module to determine the graphical configuration of the barcode, i.e. the representation thereof as it is displayed, on the display unit on the basis of this information read out, and to drive the display unit appropriately.

Furthermore, the interpretation module should include second reading elements which are able to read the meta-information of the barcode from a second section of the first region of the file. The connection between input module, interpretation module and display unit should be configured in such a way that the meta-information which is read out by the interpretation module is transferred into input elements of the input module and displayed on the display unit.

The meta-information displayed can be changed by appropriate input devices of the first computer.

Furthermore, at least one barcode producing module is provided which, on the basis of the meta-information that is changed or entered into the input elements, is also able to produce a second barcode.

Furthermore, there is at least one writing module, which enters inputs or changes in the meta-information into the second section. This, or an alternative or additional writing module, should also be capable of producing appropriate changes in the barcode in a graphical manner in the first section of the first region.

In addition, a storage device is included, in which the file having the changed first and/or second sections within the first region is stored.

Other features which are considered as characteristic for the invention are set forth in the appended claims.

Although the invention is illustrated and described herein as embodied in a method and an apparatus for producing a barcode on a substrate and data carrier, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, top-plan view showing a representation of different barcodes;

FIG. 2 is an elevational view showing a display of a PDF with meta-information on a display unit;

FIG. 3 is an elevational view showing a further display of the PDF with further selected meta-information; and

FIG. 4 is partly a perspective view and partly a block diagram of an apparatus for producing barcodes on a substrate.

### DETAILED DESCRIPTION OF THE INVENTION

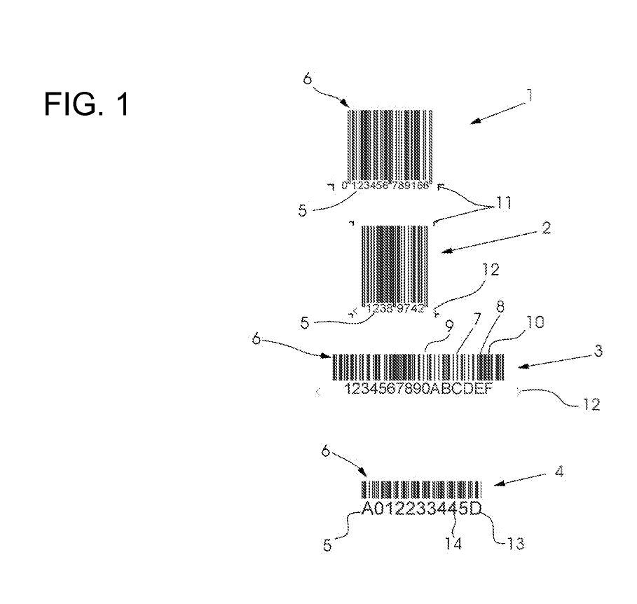

Referring now to the figures of the drawings in detail and first, particularly, to FIG. 1 thereof, there are seen four one-dimensional barcodes 1, 2, 3 and 4 as are used, for example, on outer packaging. As an alternative to the use of one-dimensional barcodes 1, 2, 3, 4, two-dimensional and at least three-dimensional barcodes as well can also be used in the method described below.

The barcodes 1, 2, 3 and 4 each are formed of human-readable elements 5 and a computer code 6. The computer code 6 is built up from lines 7 and 8 of different widths and interspaces 9 and 10 of different widths.

The barcodes 1, 2, 3, 4 in each case differ in their graphical representation, for example in the module height, i.e. the height of the lines 7, 8, in the module width, i.e. in the extent of the computer code 6 at right angles to the direction of the extent of the lines 7, 8, in the types of scripts used for the human-readable elements 5, in the content of the human-readable elements 5, in the thickness of the lines 7, 8 used, in different border markings 11, 12 used, which can be used alternatively or jointly, as illustrated in the barcode 2 and, in addition, in different widths of these border markings 11, 12 being adjustable.

The human-readable elements 5 are substantially composed of letters 13 and numbers 14. In the case of unreadable computer code 6, the letters 13 and numbers 14 can then possibly be entered into a computer by a person in a further method step, for the case in which the barcode 1, 2, 3 or 4 is to be read on non-illustrated outer packaging.

In the prior art, the barcodes 1, 2, 3, 4 are in each case stored exclusively as graphical illustrations, such as tiff or bit map (BMP), within a page description language (PDL), such as PDF. Then, if a barcode 1 is to be replaced by a barcode 2, according to the prior art, the barcode 1 would have to be erased or overwritten and the barcode 2 would have to be produced in the same way as the barcode 1, with there being no meta-information about the barcode 1.

In the method according to the invention, which is described herein, the barcode 2 does not have to be built up again completely for this purpose. Instead, recourse can be had to the information from the barcode 1 which is intended to be retained in the barcode 2. For this purpose, Form XObjects are stored in the PDF which forms the basis of the representation of the barcode 1, 2, 3, 4. The Form XObjects firstly include the graphical representation of the respective barcode 1, 2, 3, 4 and secondly provide and store the meta-information which completely describes the respective barcode.

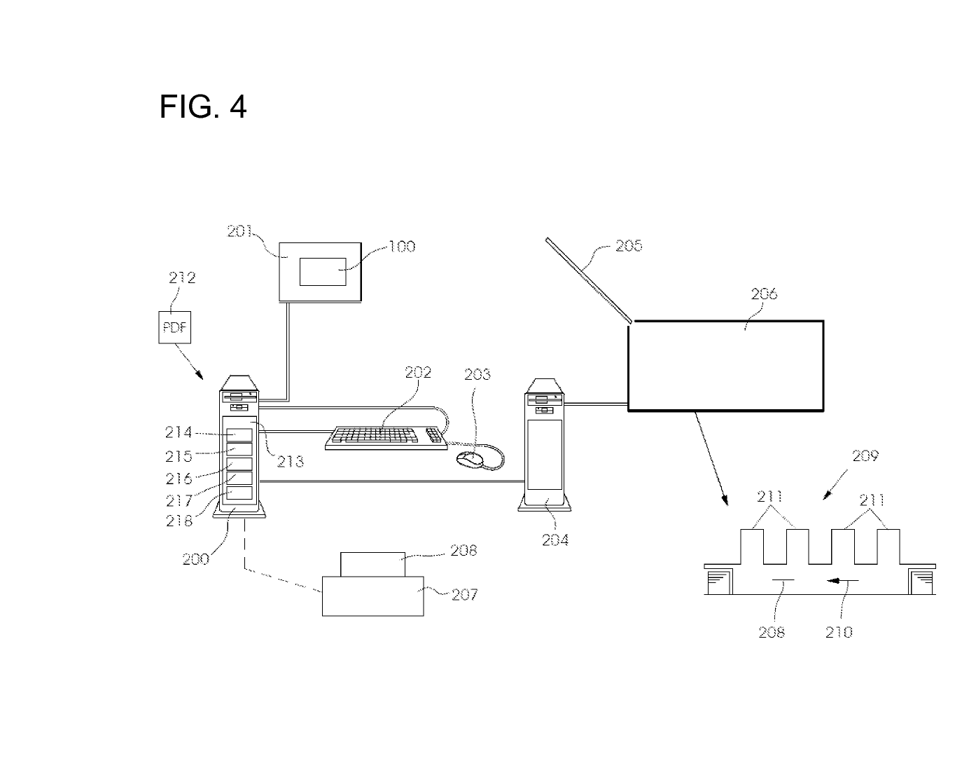

As is illustrated in FIG. 4, through the use of an interpretation module 213, which is stored as a computer program construct on a computer, the information from the Form XObjects stored in this way can be read out and displayed on a display unit 201 in a display 100.

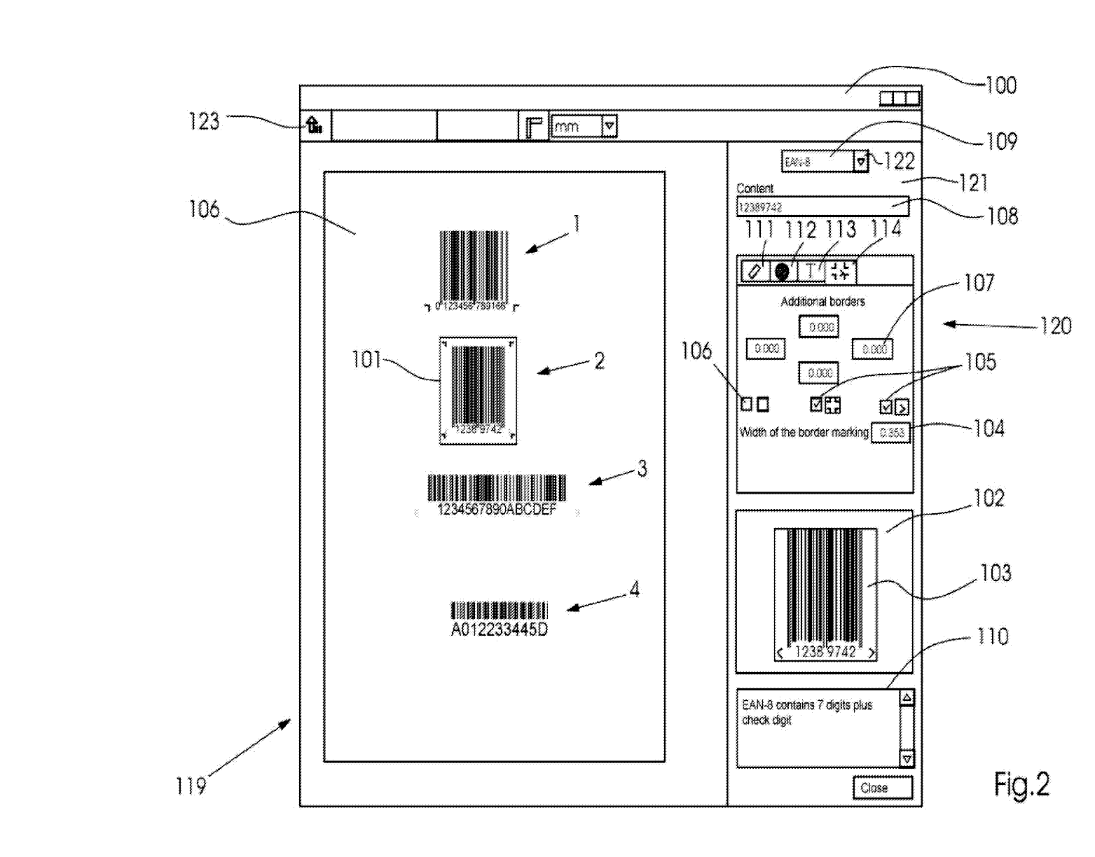

An appropriate display is illustrated in FIG. 2.

A barcode 1, 2, 3, 4 which, in this case, is displayed within a representation of a PDF display 106 in a first display window 119 on the display unit 201, can be selected through the use of a selection marking 101 by using suitable selection tools, such as a mouse cursor.

Through the selection of the barcode 2, the meta-information from a second section of the Form XObject is read out by second reading elements 215 of the interpretation module 213 as meta-information about the barcode 2 and displayed in a second display window 120. It is not necessary for the meta-information all to be displayed simultaneously. It can also be displayed successively by selecting indicated tabs 111, 112, 113, 114. In this case, provision can be made for the tabs 111, 112, 113, 114 in each case to provide thematically different meta-information about the barcode 2.

Within the input window 120 there are input elements 104, 105, 106, 107, in which the data from the meta-information stored in the selected Form XObject can be displayed first. Thus, in the input element 104, the width of the border markings 11, 12, as they are stored in the Form XObject, is displayed. The input elements 105 and 106 give information about the type of border markings 11, 12 which in each case have been selected for this barcode. The input elements 107 indicate the values for the additional borders which are provided around the barcode 2.

While the meta-information which is displayed in the input elements 104 to 107 can be replaced through the selection of different tabs 111 to 114, there is a static area for the display of specific elementary meta-information from the selected barcode 2 in a second region 121 of the display window 120. This meta-information is itself stored in corresponding input elements 108 and input elements 109 with a choice.

While the simple input elements 104 to 108 can be changed or modified or selected or discarded in each case by marking or by inputting new values, for input elements 109 with choices there is the possibility of providing a list of possible input values in a scroll-down menu. The scroll-down menu can be moved out and the desired values for this input element 109 with choice can be selected by actuating an arrow 122. In the case illustrated herein, the input element 109 with choice has the information about the type of barcode 2 being used.

In addition to the displayed and variable meta-information in the input elements 104 to 109, the information is read out from the first section of the Form XObject and displayed in a display window 102. In this case, this is the graphical representation 103 of the barcode 2 as stored in the first section of the Form XObject. This representation is identical to the representation within the PDF display 118, which is produced by interpretation of the PDF that is read out. For this purpose, the interpretation module 213 has first reading elements 214.

In addition to the meta-information from the second section and the graphical representation 103 of the Form XObject of the barcode 2, basic information, for example for the format of the barcode selected in the input element 109 with choices, can be displayed in a further display element 110.

If, then, the barcode 2 is to be modified only in individual regions, this is readily possible without the renewed input of all of the necessary parameters.

If, for example, only the content as stored in the input element 108 is to be changed, it is possible for a change to be made only in the input element 108. The barcode 2 can then readily be produced on the basis of all of the meta-information read out, as is stored in the remaining input elements 104 to 107 and 109, by activating a corresponding start switch 123. For this purpose, a first computer 200 in FIG. 4 has an appropriate barcode producing module 216. As a result of this new production of the barcode 2 through the use of the meta-information stored in the Form XObject, by using the modified individual items of the meta-information, a changed graphical representation 103 of the barcode 2 is produced in the first section of the Form XObject. In this way, with all of the meta-information read out, the changed meta-information and changed graphical representation 103, first of all a new Form XObject is produced in the random access memory, which then completely replaces the Form XObject which is stored in the PDF on which the PDF display 118 is based. In this way, in the following workflow steps and during the following production of the barcode on a substrate, the modified barcode 2 is imaged.

In this case, it may be possible, for example, that in a first operation, the content of the barcode is stored completely empty or exclusively by zeros or by other dummy values in an input element 108.

Although the barcode then still has no content to be used, all of the other features which completely describe the barcode are already known and stored in a PDF produced in the second section of the Form XObject. Such a PDF can then be produced, for example, in a customer operation or print shop. The PDF can be provided to the print shop, for example, through a data carrier or an upload over the Internet. It is only shortly before the imaging of a substrate, for example a printing plate 205 or sheet 208, as illustrated in FIG. 4, that the content of the barcode is used by carrying out the method described in a further processing station, i.e. within a computer 204, by the same program. Since all of the meta-information is retained completely in the Form XObject, all of the customer requests are taken into account in a simple way during the production of the PDFs 2 on the substrate 205, 208, without further supplementary questions.

Alternatively, it is also possible to provide for dynamic place-holders to be stored, in relation to the content in the input element 108 or in a further input element. These can be, for example, place-holders for the color of an ink separation, for the number of the printing plate or for a customer number.

Immediately before the imaging of a printing plate 205 or the imaging of a sheet 208, for example in a digital printer 207, these dynamic contents can be read out and replaced by stored actual values, such as the customer number. As a result of reading and processing the content as a function of these dynamic contents, the content in the input element 108 of the barcode 2 is finally produced just before the imaging of the substrate 205, 208. In this way, for example during the imaging of a printing plate 205 within an exposer 206, the color of the color separation of the printing plate 205 can be encoded in the content in the input element 108 of the barcode 2.

The properties of these dynamic contents can be displayed in this case on the display unit 201 within the display 100, for example in the display element 110 or in alternative display elements.

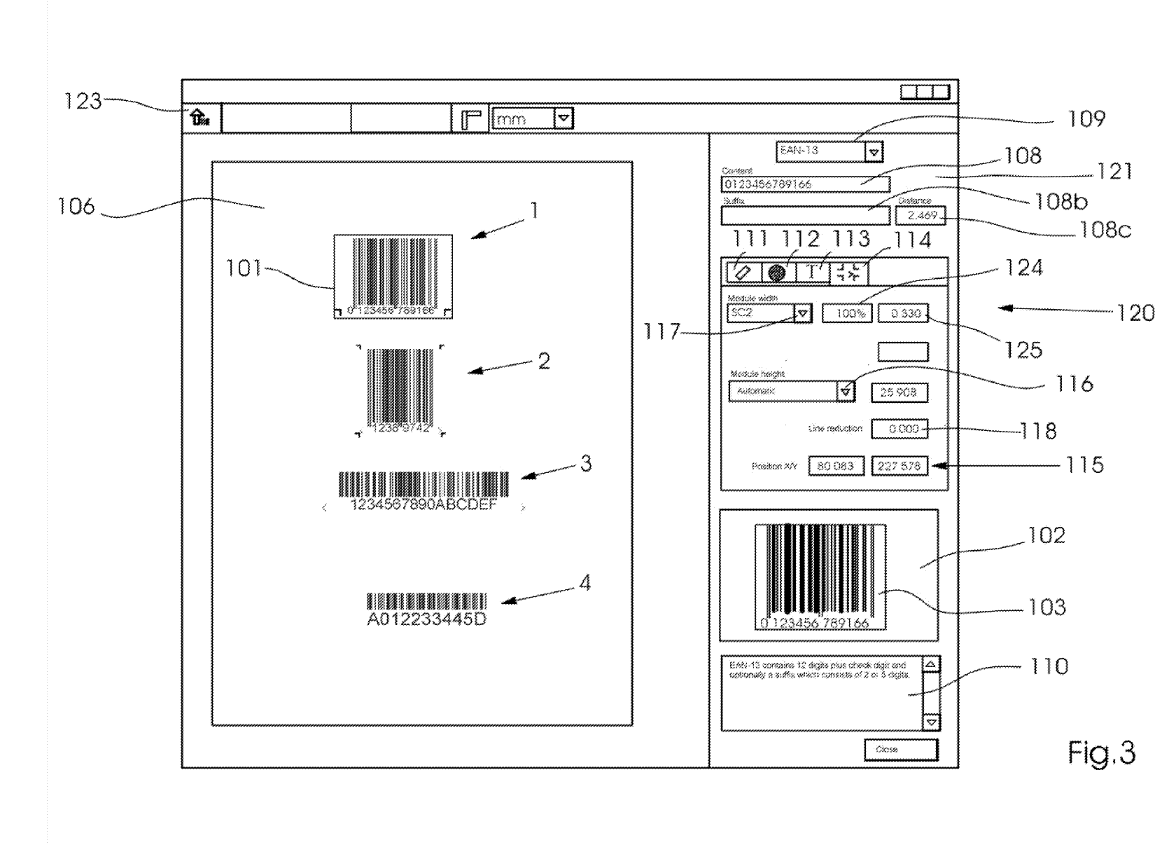

FIG. 3 shows, by way of example, a second selection of input elements 115, 118, 108b, 108c and input elements 116, 117 with choices.

These input elements 108b, 108c and 115 to 118 can be selected by selecting the tab 111.

As described above, first of all the meta-information which is stored in a second section of the Form XObject of the selected barcode 1 is written into these input elements 108 to 110 and 115 to 118. In the case shown herein, the barcode 1 is selected through the use of the selection marking 101. Depending on the selected format of the barcode 1 in the input element 109 with choices 109, additional input elements 108b and 108c can be provided in the second region 121 of the display window 120.

The use of these input elements 108b, 108c can be described, for example, in the display element 110. In this case, for example, input elements 108b for the input of dynamic contents can also be provided.

In order to select the module width within an input element 117 with choice, predefined values can be provided in input elements 124, 125 when changing the module width. These can then be varied further. The same is true of the module height in an input element 116 with choice. The module height can be input automatically or manually. Such assignments are generally possible for input elements with choice.

The barcode 1 can be displaced in a simple way, through the position which is stored in an input element 115, without any changes to the content within the PDF on which the PDF display 106 is based, so that the PDF display 106 is adapted appropriately and the barcode 1 is positioned appropriately on a substrate 205 or 208.

FIG. 4 illustrates an appropriate structure for producing barcodes 1, 2, 3, 4 on substrates 205, 208. The substrates 205, 208 are, for example, printing plates 205 or sheets 208, which are imaged within a printing press 209 by using an imaged printing plate 205 or in a digital printer 207.

The structure illustrated therein can, for example, be the structure within a print shop. The print shop obtains a PDF 212 in electronic form from one of their customers. This can be carried out through a data carrier, such as a DVD, CD, USB stick, or through the use of a data stream, for example through the Internet. This PDF is then read into a first computer 200. Stored within this PDF is a first barcode 1, which is stored graphically in a Form XObject in a first section as a graphical representation 103. In addition to the graphical representation 103, the above-described meta-information which completely describes the barcode 1 is also in the same Form XObject of the PDF 212.

The barcode 1 is displayed within a PDF display 106 within a display 100 on a display unit 201 which is connected to the computer 200, by using all of the information from the Form XObject of the PDF 212 and by using an interpretation module 213 with first and second reading elements 214 and 215. In this case, the first reading element reads the data from a first section of the Form XObject which relates to the graphical representation 103 of the barcode 1, and displays that data appropriately on the PDF display 106 and within the display element 110 of the display 100. Through the use of the second reading element 215, the meta-information from the second section of the Form XObject is read out and entered into the described input elements 104 to 108, 108b, 108c, 115, 118, 124,125 and the input elements 109, 116, 117 with choices. The PDF 1 can be selected through the use of a selection marking 101 using input devices in the form of a keyboard 202 and a mouse 203, and thus displayed with meta-information in the aforementioned input elements. Given the aid of the mouse 203 and the keyboard 202, this meta-information can then be modified in accordance with further stipulations. Following this modification, a new Form XObject having an appropriately adapted barcode 2 with a corresponding graphical representation 103 is produced, with this Form XObject replacing the original Form XObject in the PDF 212. In this case, reference is expressly made once more to the fact that the meta-information in the second information of the Form XObject does not have to be stored through the use of tools, elements or as code which correspond to the page description language but can be produced in a proprietary manner in a private region.

The newly produced Form XObject is produced by changed or newly input meta-information being entered into at least the second section of the Form XObject through the use of a writing module 217. Then, the PDF 212 provided with the newly produced Form XObject is stored on a hard disk 218 as a storage medium. Alternatively, other storage media, such as network storage devices, USB memories, flash drives and the like, can also be used as a storage medium.

The modified PDF 212 produced in this way is used as a basis for imaging a sheet 208. The sheet 208 can alternatively be imaged in a digital printer 207 or in a printing press 209. Instead of or in addition to the sheet 208, a printing plate 205 can also be imaged in a plate exposer 206. This is necessary, in particular, when the sheet 208 is to be imaged in a conventional offset printing press 209 in inking units 211. For the purpose of imaging within an offset printing press 209, the PDF is sent or transferred to a further computer 204, which can be provided with the same input and output possibilities as the first computer 200. In this case, in particular, the access to the changed PDF 212 can be made again and both the barcode can be changed with new information and dynamic contents of the content stored in the input element 108 of the barcode 2 can be generated or replaced. On the basis of the PDF 212 adapted in this way, bitmap data are then generated through the use of an RIP, with it being possible for the RIP in particular to be a constituent part of the computer 204. This bitmap data is used to image the printing plate 205 point by point in the plate exposer 206. In this way, the modified barcode 2 is already produced on the printing plate 205 as the substrate. In this case, the production of the barcode 2 can be carried out, in particular, in the region of the printing plate 205 which is not provided to be imaged in a printing press 209. In this case, for example through the use of dynamic contents, the color separation of the printing plate 205 can be stored, so that the use of the printing plate 205 within the printing press 209 is supported. Furthermore, the printing plate 105 is clamped in an inking unit 211 of the printing press 209, the printing material 208 is transported through the printing press 209 in the transport direction 210 and imaged in the individual inking units 211 through the use of the printing plates 205, so that the modified barcode 2, for example for use for outer packaging, is imaged on the sheet 208 with the most up-to-date information, which has been input in the computer 204 or in the computer 200.

Imaging takes place alternatively in a digital printing press or in a printer 207, by driving this printer 207 appropriately through the use of a driver of the computer 200 on the basis of the modified PDF 212 and, in this way, the modified barcode 2 being produced on the sheet 208.

In this way, the barcode can be supplied with current information at any time within the workflow, without complete re-generation of the barcode 1, 2, 3 or 4 with the new input of all of the meta-information being necessary.

1. A method for imaging a substrate to produce an image on a surface of the substrate and to produce at least one image region containing a barcode, the method comprising the following steps:
producing a file on a first computer in a page description language, the file including a printing original for imaging the substrate;
creating a first section, describing a first barcode, within a first region of the file and making the first region unambiguously identifiable by using identification elements of the page description language;
storing the file on a storage medium or sending the file as a data stream to a second computer, following production of the file;
re-opening the file with the first or second computer;
identifying the first region of the file using the identification elements;
accessing the first barcode and making changes to at least one of individual parameters or contents of the first barcode;
producing a first region with changed content within the file by using at least one of the changed parameters or contents; and
on the basis of the file, imaging the substrate in an imaging device and physically producing the barcode in the at least one image region while taking at least one of the changed parameters or changed content into account.

2. The method according to claim 1, wherein the page description language is PDF.

3. The method according to claim 1, which further comprises storing the barcode in the first section of the first region in a graphical representation.

4. The method according to claim 1, which further comprises:
creating at least one second section in the first region of the file; and
storing meta-information relating to the description of the barcode in the at least one second section.

5. The method according to claim 4, which further comprises:
producing the file having the first region in a first step;
producing the first section encoding the first barcode, in the first region;
producing the at least one second section encoding first meta-data from the first barcode, in the first region;
re-opening the file in the first or second computer;
decoding the first region;
accessing the first meta-data from the at least one second section and changing or replacing the first meta-data to produce second meta-data;
producing a second barcode on the basis of the second meta-data;
producing a second region having a first and a second section;
including the second barcode in the first section of the second region and including the second meta-data in the second section of the second region; and
replacing the first region of the file with the second region and producing an image on a substrate by using the second barcode, on the basis of the changed file.

6. The method according to claim 5, which further comprises:
producing a third section within the first region;
storing data relating to the content of the second barcode, in the third section;
storing the data in the form of place-holders;
replacing the place-holders with a predefined value in order to produce the second barcode on the substrate; and
producing the second barcode in the first section or on the substrate, on the basis of the data from the second and third sections.

7. The method according to claim 1, which further comprises:
producing the first region in the form of a first Form XObject of a PDF file; and
including the barcode in the Form XObject in the form of graphical elements in the first section and at least one item of meta-information selected at least from the group consisting of type, position, layout-specific positions, relative position determination, module height, module width, line reduction, background color, foreground color, color rule, border, distance marker definition, character set, character size and text content of the barcode contained in a second section.

8. The method according to claim 7, which further comprises:
in a first step, producing the Form XObject and producing the barcode in relation to a text content thereof without any actual content in the manner of a dummy barcode;
further processing the file having the Form XObject within a workflow for printed product production;
before the imaging of the substrate, replacing the dummy barcode with a specific barcode by using at least one of the meta-information from the second section or the data from a third section, while adapting the meta-data appropriately in relation to the text of the specific barcode; and
producing a second Form XObject having the selected barcode and the adapted meta-information and replacing the first Form XObject with the second Form XObject.

9. The method according to claim 1, which further comprises:
transmitting an original file having an original barcode to the first computer;
covering or deleting the original barcode within the original file; and
producing the file having the first region including the first barcode in the first section, on the basis of the original file.

10. A data carrier, comprising:
a computer program stored on the data carrier for carrying out the method according to claim 1.

11. An apparatus for imaging a substrate with an image having at least one image region containing a barcode, the apparatus comprising:
at least one of a printing plate imaging device or a printing press;
at least one first computer configured for producing a barcode to carry out the method according to claim 1;
said first computer having at least one input unit and a display unit;
said first computer including an interpretation module for interpretation of a file in a page description language, said file having a first region with first and second sections;
said interpretation module configured to interpret said file and display said file graphically on said display unit;
said first computer including at least one input module;
said at least one input module having input elements for inputting meta-information from the barcode;
said interpretation module and said at least one input module having an information connection to each other;
said interpretation module including first reading elements reading information out of said first section of said first region of said file;
said interpretation module determining a representation of the barcode as displayed on said display unit on a basis of information read out of said first section and correspondingly driving said display unit;
said interpretation module including second reading elements reading meta-information from the barcode out of said second section of said first region of said file;
said interpretation module being connected to said at least one input module for displaying the meta-information in input elements of said at least one input module on said display unit;
said first computer having an input device permitting inputs or changes of the displayed meta-information within said input elements of said at least one input module;
at least one barcode producing module configured to produce a second barcode on a basis of the meta-information being changed or entered into said input elements;
at least one writing module at least one of entering inputs or changes in the displayed meta-information into said second section of said first region or entering the second barcode into said first section of said first region; and
a storage device storing a file having at least one of first or second correspondingly changed sections in said first region.
